(19) United States
(12) Patent Application Publication
(10) Pub. No.: US 2025/0094184 A1
(43) Pub. Date: Mar. 20, 2025

(54) SYSTEM AND A METHOD FOR ASSISTIVE COOKING

(71) Applicant: React Labs Private Limited, Bengaluru (IN)

(72) Inventors: Chaitanya HEGDE, Bengaluru (IN); Mahek Mody, Bengaluru (IN); Amrutha Manjappa, Bengaluru (IN)

(21) Appl. No.: 18/884,862

(22) Filed: Sep. 13, 2024

(30) Foreign Application Priority Data
Sep. 15, 2023 (IN) 202341062146

(51) Int. Cl. G06F 9/451; G06F 40/58; G06V 10/40; G10L 15/26

(52) U.S. Cl. CPC G06F 9/451; G06F 40/58; G06V 10/40; G10L 15/26

(57) ABSTRACT

The present subject matter relates to a system and a method for assistive cooking. The system includes a device coupled with a user interface (UI) which is configured to receive one or more user inputs in form of text, audio, image, or video. Further, the system generates one or more text instructions based on the received one or more user inputs, using an AI model. Furthermore, the system generates a set of cooking directions based on the generated one or more text instructions, using the AI model. Moreover, the system displays the generated set of cooking directions on the UI, thereby allowing a user to interact. Overall, the system provides an efficient, AI-driven solution for assistive cooking, enhancing user convenience by simplifying the process of generating and following personalized cooking directions.

### CROSS-REFERENCE TO RELATED APPLICATIONS AND PRIORITY

The present application claims priority from the Indian provisional patent application, having application number 202341062146, filed on 15 Sep. 2023, incorporated herein by a reference.

### FIELD OF INVENTION

The presently disclosed embodiments are related, in general, to the field of an intelligent or smart system for assistive cooking and method thereof. More particularly, the present disclosure relates to improving user experience or interaction with cooking appliances using artificial intelligence (AI) based assistive cooking.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In today's environment, a growing number of consumers choose to prepare the meals they eat at home rather than going to conventional restaurants or other establishments. This rise can be attributed, in part, to the growing importance of eating fresh foods with minimally processed ingredients, people's desire to prepare their own food, the proliferation of better-quality and more energy-efficient cooking appliances, and the rise of cooking television programs and online digital content that offer step-by-step instructions for cooking a variety of foods.

Cooking instructions for preparing food are widely available and can be found in cookbooks, the product literature of appliance and cookware manufacturers, user contributions to websites, magazines, and digital versions of those publications, as well as on commercial websites. Modern cooking appliances including, but not limited to oven, microwave heating devices can now be controlled by portable computer devices due to advancements in processing, graphical user interface, and network connectivity technology for devices like tablets and smartphones.

Conventionally, the cooking appliance can be operated in manual mode and adhere to a recipe that is not included with the application program, the user will ultimately need to follow the recipe's instructions. This may involve manually adjusting the temperature and time. This occasionally necessitates the user manually converting hazy or generic descriptions offered in such a recipe into inputs that the cooking device can follow very accurately. In other situations, users can just use the appliance's manual settings to make the food item according to the recipe the old-fashioned way. However, it should be noted that doing manual conversions into inputs and/or using manual settings on an appliance can be very time-consuming and difficult for users, particularly for users who are not experienced cooks. Further, existing cooking appliances fail to provide present recipes in a user-friendly format. Furthermore, existing cooking appliances fail to adapt to the user's specific taste and needs.

In addition to the challenges outlined above, conventional cooking systems face limitations in accepting multi-modal inputs in the form of text, video or audio. These systems often lack the capability to process such media effectively to derive actionable cooking instructions or generate new recipes. Users who wish to provide cooking-related inputs via video demonstrations or voice commands frequently find themselves restricted to manual input methods, such as typing or selecting from pre-defined menus, limiting the flexibility and convenience that modern users expect from smart devices. This inability to utilize multi-modal inputs (video, audio, etc.) hinders user engagement and reduces the overall efficiency of the cooking process.

Another major limitation in conventional cooking systems is their inability to offer real-time modification of cooking instructions based on user input. Even when a system provides preset cooking directions, it often does not allow users to make adjustments based on their taste preferences or specific needs, such as ingredient substitutions, cooking time adjustments, or dietary restrictions. This rigidity forces users to either follow the instructions exactly which affects the taste and experience or manually adjust the appliance settings, which can be cumbersome and error prone. Additionally, systems that do allow for modification often require the user to revert to manual input modes, detracting from the overall convenience of using a smart, automated cooking assistant.

Conventional systems often fail to provide a high level of customization based on user preferences. Factors such as specific dietary restrictions (e.g., gluten-free or vegan), cultural preferences, or ingredient substitutions based on local availability are not easily accommodated. This lack of personalization makes it challenging for users to adapt recipes to their unique needs, significantly limiting the utility of such systems in modern kitchens where individual tastes and health considerations are increasingly important.

Additionally, even when users attempt to modify a given recipe, conventional systems usually require them to manually adjust cooking times, temperatures, or ingredient quantities. This process can be time-consuming, and for users unfamiliar with recipe adjustments or cooking appliances, it introduces the risk of errors. As a result, existing cooking systems fall short in adapting to modern user preferences, which demand flexibility, personalization, and ease of use. The absence of features to handle multi-modal inputs and offer real-time recipe modifications leads to a suboptimal user experience, particularly for those who seek efficiency and creativity in the kitchen.

In light of the above stated discussion, there exists a need of a system and a method for improving user cooking experience by assistive cooking to overcome at least one of the above stated disadvantages.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated in a present disclosure, a system for assistive cooking is disclosed. In one implementation of the present disclosure, the system may involve a device communicatively coupled with a user interface (UI). Further, the device may involve a processor and a memory. The memory is communicatively coupled to the processor. Further, the memory is configured to store processor executable instructions, which, on execution, may cause the processor to receive one or more user inputs, via the UI, for generating a set of cooking directions. In an embodiment, the processor executable instructions may comprise an artificial intelligence (AI) model. The one or more user inputs may comprise one of a text input, an audio input, an image input, a video input or a combination of the same. Further, the processor may be configured to generate one or more text instructions, utilizing the AI model, based on the one or more user inputs. Furthermore, the processor may be configured to generate the set of cooking directions, utilizing the AI model, based on the one or more text instructions. Moreover, the processor may be configured to display the set of cooking directions on the UI coupled with the device. In an embodiment, a user may interact with the UI for executing the set of cooking directions on the device.

According to embodiments illustrated herein, there is provided a method for assistive cooking in a device. In one implementation of the present disclosure, the method may involve various steps performed by a processor of the device. The method may involve a step of receiving, via the user interface (UI) communicatively coupled with the device, the one or more user inputs for generating the set of cooking directions. In an embodiment, the format of the one or more user inputs may comprise one of the text input, the audio input, the image input, the video input or a combination of the same. Further, the method may involve a step of generating, via the processor, the one or more text instructions, utilizing the AI model, based on the one or more user inputs. Furthermore, the method may involve a step of generating the set of cooking directions, utilizing the AI model, based on the one or more text instructions. Moreover, the method may involve a step of displaying the set of cooking directions on the UI coupled with the device. In an embodiment, the user may interact with the UI for executing the set of cooking directions on the device.

According to embodiments illustrated herein, there is provided a non-transitory computer-readable storage medium having stored thereon, a set of computer-executable instructions causing a computer comprising one or more processors to perform various steps. The steps may involve receiving the one or more user inputs for generating the set of cooking directions. In an embodiment, the format of the one or more user inputs may comprise one of the text input, the audio input, the image input, the video input or a combination of the same. Further, the steps may involve generating the one or more text instructions, utilizing an AI model, based on the one or more user inputs. Furthermore, the steps may involve generating the set of cooking directions, utilizing the AI model, based on the one or more text instructions. Moreover, the step may involve displaying the set of cooking directions on the user interface (UI) coupled with the device. In an embodiment, the user may interact with the UI for executing the set of cooking directions on the device.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The accompanying drawings illustrate the various embodiments of systems, methods, and other aspects of the disclosure. Any person with ordinary skills in art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, same numbers are used throughout the drawings to refer like features and components. Embodiments of a present disclosure will now be described, with reference to the following diagrams below wherein:

FIG. 1 illustrates a block diagram describing a system (100) for assistive cooking, in accordance with at least one embodiment of the present disclosure.

FIG. 2 illustrates a block diagram (200) showing an overview of various components of an application server (101) configured for the assistive cooking, in accordance with at least one embodiment of the present disclosure.

FIG. 3 illustrates a flowchart describing the method (300) for assistive cooking, in accordance with at least one embodiment of the present disclosure; and

FIG. 4 illustrates a block diagram (400) of an exemplary computer system (401) for implementing embodiments consistent with the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The terminology “set of cooking directions”, “recipes”, and “cooking instructions” has the same meaning and are used alternatively throughout the specification. Further, the terminology “one or more user inputs”, “user inputs”, and “user input” has the same meaning and are used alternatively throughout the specification. The terminology “user”, “users” and “one or more users” has the same meaning and are used alternatively throughout the specification. Further, the terminologies “device”, “appliance”, “smart device”, “cooking device”, “cooking appliance”, “cooking appliances” has the same meaning and are used alternatively throughout the specification.

The present disclosure relates to a system for assistive cooking via cooking device. The system comprises the cooking device communicatively coupled with a user interface (UI). Further, the device comprises a processor and a memory communicatively coupled to the processor, and the memory is configured to store processor-executable instructions including an artificial intelligence (AI) model. Further, the system enables the processor coupled with the AI model, to receive one or more user inputs, via the UI of the cooking device for generating a set of cooking directions. The one or more user inputs may include one of a text input, an audio input, an image input, a video input or a combination of the same. Further, the system may generate one or more text instructions, based on the one or more user inputs. Furthermore, the system may generate the set of cooking directions, utilizing the AI model, based on the one or more text instructions. Moreover, the system may display the set of cooking directions on the UI coupled with the cooking device. A user may interact with the UI of the cooking device for executing the set of cooking directions on the cooking device.

To address the problems of conventional systems, the disclosed system integrates advanced technologies to transform the user interaction with the cooking appliance during the cooking process. By incorporating the AI model, the system efficiently interprets various formats of one or user inputs including text, audio, images, and video to generate and customize cooking instructions. This automation of recipe generation and real-time assistance allows the users to make adjustments based on their taste preferences, dietary restrictions or specific needs. The system dynamically adjusts cooking directions based on user preferences, dietary needs, cultural requirements, and ingredient availability, reducing the need for manual intervention. By leveraging the AI to interpret and process various formats of user inputs and by automatically personalizing recipes and its integration with the cooking device for automatic execution, the system significantly enhances the user experience, improves cooking efficiency, and reduces the complexity involved in adapting recipes. Consequently, the system simplifies the cooking and enhances the user experience, making it easier and faster to get accurate, customized cooking directions.

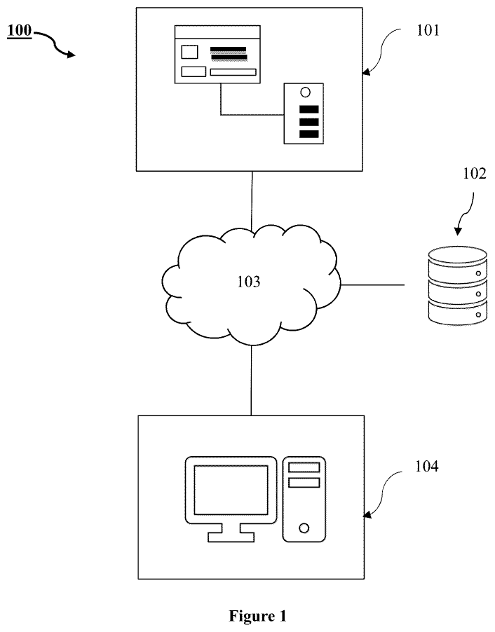

Referring to FIG. 1 is a block diagram that illustrates a system (100) for assistive cooking comprising the device communicatively coupled with the UI, in accordance with at least one embodiment. The system (100) typically includes an application server (101), a database server (102), a communication network (103), and a user computing device (104). The application server (101), the database server (102), and the user computing device (104) are typically communicatively coupled with each other via the communication network (103). In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that may be configured to store one or more vector databases, one or more vector content, cooking device specific configuration data, domain specific data, training data, one or more recipe validation rules, one or more device safety check and validation rules, user profile information, user food preferences, dietary preferences, ingredients information, nutritional information and one or more predefined thresholds. In an embodiment, the database server (102) may include a special purpose operating system specifically configured to perform one or more database operations on the generated one or more text instructions. In an embodiment, the database server (102) may include one or more instructions specifically for storing the one or more vector databases comprising the one or more vector content. In an embodiment, the system (100) may be configured to extract one or more content from the one or more vector databases based on a query vector. Further, the one or more vector databases may be specifically configured to compare the query vector with the one or more vector content of the one or more vector databases based on one or more similarity scores and one or more predefined thresholds. In an embodiment, the one or more vector databases may be configured to periodically update the one or more vector content with latest recipe and device functionalities. In an exemplary embodiment, each vector database from the one or more vector databases corresponds to one or more parameters selected from recipes, cooking modes, various cooking settings, device specific recipe structure, ingredient list and detailed ingredient-based information, cuisine and diet-based information and custom domain knowledge. Examples of database operations may include, but are not limited to, storing, retrieving, comparing, and updating data. In an embodiment, the database server (102) may include hardware that may be configured to perform one or more specific operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for assistive cooking, and periodically updating the one or more vector content with latest recipe and device functionalities.

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in one or more memories for supporting the hosted application or the software service. In an embodiment, the hosted application or the software service may be configured to perform one or more specific operations. The application server (101) may be realized through various types of application servers such as, but are not limited to, a Java application server, a .NET framework application server, a Base4 application server, a PHP framework application server, or any other application server framework.

In another embodiment, the application server (101) may be configured to utilize the database server (102) and the user computing device (104), in conjunction, for assistive cooking. In an implementation, the application server (101) is configured for an automated processing of the one or more user inputs in various formats, such as text, audio, image, or video, to generate personalized cooking instructions. Further, the application server (101) monitors user interactions, identifies potential issues, such as missing ingredients or deviations from standard cooking steps, and executes predefined corrective actions. This ensures efficient adaptation of recipes based on user preferences, dietary needs, or ingredient availability, thereby enhancing the overall cooking experience.

In yet another embodiment, the application server (101) may be configured to receive the one or more user inputs, via the UI, for generating a set of cooking directions. In an embodiment, format of the one or more user inputs may include, but not limited to, one of the text input, the audio input, the image input, the video input or a combination of the same.

In yet another embodiment, the application server (101) may be configured to generate the one or more text instructions, utilizing the AI model, based on the one or more user inputs.

In yet another embodiment, the application server (101) may be configured to generate the set of cooking directions, utilizing the AI model, based on the one or more text instructions.

In yet another embodiment, the application server (101) may be configured to display the set of cooking directions on the UI coupled with the device. In an embodiment, the user may interact with the UI for executing the set of cooking directions on the device.

In an embodiment, the communication network (103) may correspond to a communication medium through which the application server (101), the database server (102), and the user computing device (104) may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise one or more processors and one or more memory. The one or more memories may include computer readable code that may be executable by one or more processors to perform specific operations. In an embodiment, the user computing device (104) may present a web user interface to transmit the user input to the application server (101). Example web user interfaces presented on the one or more portable devices to display the generated set of cooking directions to the user to facilitate interaction within the system (100). Examples of the user computing devices may include, but are not limited to, a personal computer, a laptop, a personal digital assistant (PDA), a mobile device, a tablet, cooking appliance, cooking device, a blending device, a microwave oven, other smart kitchen devices or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can leverage the AI to interpret and process various formats of user inputs and by automatically personalizing recipes and its integration with the cooking device for automatic execution, the system (100) significantly enhances the user experience, improves cooking efficiency, and reduces the complexity involved in adapting recipes. In a specific embodiment, the system (100) is implemented for assistive cooking.

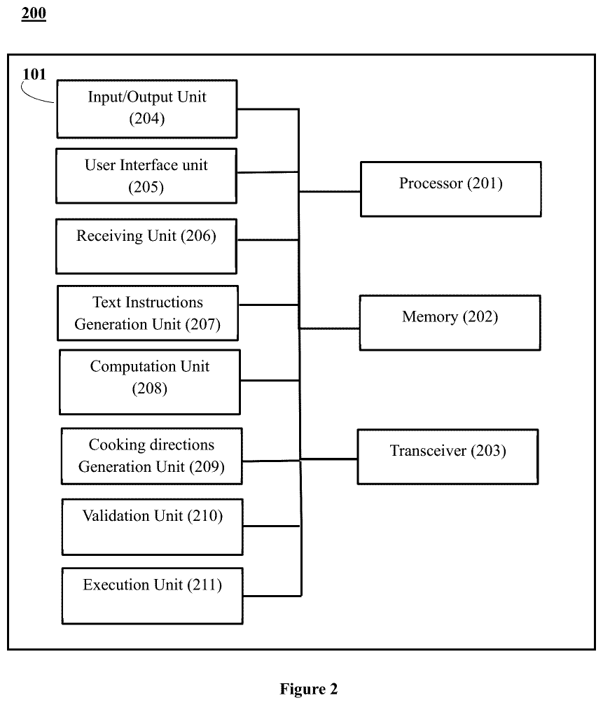

Now referring to FIG. 2, illustrates a block diagram (200) showing an overview of various components of the application server (101) configured for the assistive cooking, in accordance with at least one embodiment of the present disclosure. FIG. 2 is explained in conjunction with elements from FIG. 1. In an embodiment, the application server (101) includes a processor (201), a memory (202), a transceiver (203), an input/output unit (204), a user interface unit (205), a receiving unit (206), a text instructions generation unit (207), a computation unit (208), a cooking directions generation unit (209), a validation unit (210) and an execution unit (211). The processor (201) may be communicatively coupled to the memory (202), the transceiver (203), the input/output unit (204), the user interface unit (205), the receiving unit (206), the text instructions generation unit (207), the computation unit (208), the cooking directions generation unit (209), the validation unit (210), and the execution unit (211). The transceiver (203) may be communicatively coupled to the communication network (103) of the system (100).

In an embodiment, the application server (101) may be configured to receive the one or more user inputs, via the UI, for generating the set of cooking directions. The format of the one or more user inputs may include, but not limited to, one of the text input, the audio input, the image input, the video input or a combination of the same. Further, the application server (101) may be configured to generate the one or more text instructions, utilizing the AI model, based on the one or more user inputs. Furthermore, the application server (101) may be configured to generate the set of cooking directions, utilizing the AI model, based on the one or more text instructions. Moreover, the application server (101) may be configured to display the set of cooking directions on the UI coupled with the device. In an exemplary embodiment, the user may interact with the UI of the cooking device for executing the set of cooking directions on the device.

The processor (201) comprises suitable logic, circuitry, interfaces, and/or code that may be configured to execute a set of instructions stored in the memory (202), and may be implemented based on several processor technologies known in the art. The processor (201) works in coordination with the memory (202), the transceiver (203), the input/output unit (204), the user interface unit (205), the receiving unit (206), the text instructions generation unit (207), the computation unit (208), the cooking directions generation unit (209), the validation unit (210), and the execution unit (211) for enabling assistive cooking to users. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output (I/O) unit (204) comprising input device namely keyboard, touchpad, trackpad may be configured to receive the text input of the one or more inputs. In an embodiment, the microphone may be configured to receive the audio input of the one or more inputs. In an embodiment, the visual camera is configured to capture one of the image input, the video input, or a combination of the same.

Further, the user interface unit (205) may include the user interface (UI) displaying specific operations such as generating and displaying the set of cooking directions to the user. In an embodiment, the user interacts with the UI, through voice command or text command, for executing the set of cooking directions on the device. In an embodiment, the user interacts with the UI for executing the set of cooking directions on the device. In an exemplary embodiment, the UI may display current cooking status, instructions being executed, and any adjustments made to the cooking process based on user preferences Furthermore, the user interface unit (205) may include interfaces for various content formats such as text, image, video, and audio. These components work together to allow the user to input data, such as ingredients or recipes, through various formats including text, audio, video, or images. This enables the user to manage and modify cooking tasks in real-time according to user preferences. Furthermore, the user interface unit (205) may facilitate interaction between the user and the device by presenting relevant data, alerts, and notifications about specific operations performed by the device, via the UI. This addresses the limitations of conventional systems by allowing more intuitive user input and dynamic adjustment of recipes based on personal preferences, thereby enhancing the assistive cooking experience.

Further, the receiving unit (206) may be configured to receive the one or more user inputs, via the UI, for generating a set of cooking directions. In an embodiment, format of the one or more user inputs may include, but not limited to, one of the text input, the audio input, the image input, the video input or a combination of the same. In an exemplary embodiment, the received text input may include recipe name, recipe description, list of ingredients, web address, or user queries. In another exemplary embodiment, the received audio input may include voice instructions from the user. In yet another exemplary embodiment, the received image input may include one or more images of ingredients, food dishes, or cooking instructions. In yet another embodiment, the image input may correspond to selecting one or more images stored in the memory (202). In yet another exemplary embodiment, the received video input may include video instructions from the user. In another embodiment, the video input may correspond to selecting one or more videos stored in the memory (202).

Further, the text instructions generation unit (207) may be configured to generate the one or more text instructions by utilizing the AI model, based on the one or more user inputs. In an exemplary embodiment, generating the one or more text instructions may correspond to interpreting the text input and categorizing into one of, but not limited to, a plaintext, one or more web addresses or a combination of the same. A variety of text analysis tools or techniques such as Natural Language Processing (NLP), Large Language Model (LLM) may be used to interpret and categorize text. The AI model may support multi-language support where the one or more user inputs (either in text, audio, image or video) captured in any language can be translated into an English language for further processing. In another exemplary embodiment, generating the one or more text instructions may correspond to transcribing the audio input using one or more speech recognition techniques. A variety of speech recognition techniques, speech-to-text techniques may be used to perform audio transcribing. In yet another exemplary embodiment, generating the one or more text instructions may correspond to analyzing the image input using one or more image recognition techniques to identify textual description of ingredients, food dishes, or cooking instructions from the image input. In an exemplary embodiment, a variety of optical character recognition (OCR) techniques may be utilized, supporting multiple languages, to perform the image recognition. In yet another exemplary embodiment, generating the one or more text instructions may correspond to analyzing the video input using one or more video recognition techniques to identify textual description of ingredients, food dishes, or cooking instructions from the video input. In yet another exemplary embodiment, generating of the one or more text instructions may include translating language of the one or more user inputs into an English language for further processing.

Furthermore, the one or more web addresses may correspond to one of a video streaming platform address, a webpage address, or a combination of the same. In an exemplary embodiment, generating of the one or more text instructions may include one of navigating to the webpage address, extracting recipe metadata from a webpage associated with the webpage address, downloading of video corresponding to the video streaming platform web address, extracting video metadata from the downloaded video, generating audio transcription of the downloaded video, summarization of the recipe metadata and the video metadata into one or more text instructions. In another exemplary embodiment, downloading of the video may be performed by utilizing one or more application programming interface (API) corresponding to a video streaming platform associated with the video streaming platform address.

Furthermore, the computation unit (208) may be configured to generate a query vector based on the one or more text instructions generated by the text instruction generation unit (207). Furthermore, the computation unit (208) may be configured to extract one or more content from one or more vector databases based on the query vector. The one or more vector databases comprise one or more vector content. Extracting the one or more content may be performed by comparing the query vector with the one or more vector content of the one or more vector databases based on one or more similarity scores and one or more predefined thresholds. In an exemplary embodiment, the one or more similarity scores may correspond to retrieving relevant recipes, ingredients, or instructions.

In another exemplary embodiment, the one or more predefined threshold may correspond to recipe-generated parameters including minimum number of steps involved for generation of recipe, minimum number of ingredients required to generate a recipe, or more.

In an exemplary embodiment, each vector database from the one or more vector databases may comprise one or more parameters selected from recipes, cooking modes, various cooking settings, device specific recipe structure, ingredient list and detailed ingredient-based information, cuisine and diet-based information and custom domain knowledge. In a related embodiment, the one or more vector databases may be configured to periodically update the one or more vector content with latest recipe and device functionalities.

Furthermore, the computation unit (208) may be configured to combine the one or more text instructions to form one or more AI compatible queries. In an embodiment, the AI model may be configured to generate the set of cooking directions based on the one or more AI compatible queries. More specifically, the cooking directions generation unit (209) may be configured to generate the set of cooking directions by utilizing the AI model, based on the one or more AI compatible queries. In an embodiment, the one or more AI compatible queries may include the one or more user inputs, similar recipes, ingredients data, cuisine and diet data, device specific instructions, and custom settings. Another terminology corresponding to the AI compatible queries is AI Prompt.

In an embodiment, the cooking directions generation unit (209) may be configured to generate the set of cooking directions, utilizing the AI model, based on the one or more text instructions. Furthermore, the cooking directions generation unit (209) coupled with the processor (201), may be configured to generate the set of cooking directions by utilizing the AI model, based on the one or more content extracted from one or more vector databases.

Furthermore, the cooking directions generation unit (209) may be configured to combine the one or more content to form one or more AI instructions. In an exemplary embodiment, the AI model may be configured to generate the set of cooking directions based on the one or more AI instructions. More specifically, the cooking directions generation unit (209) coupled with the processor (201), may be configured to generate the set of cooking directions by utilizing the AI model, based on the one or more AI instructions. In an exemplary embodiment, the one or more AI instructions may include the one or more user inputs, similar recipes, ingredients data, cuisine and diet data, device specific instructions, and custom settings. Another terminology corresponding to the AI instructions is AI Prompt.

Moreover, the cooking directions generation unit (209) may be configured to generate the set of cooking directions in a predefined data exchange format. In an exemplary embodiment, the set of cooking directions in the predefined data exchange format may include attributes from one of cooking time, steps-by-step guidelines, ingredient measurements, nutritional information, device-specific instructions, and a combination of the same. The predefined data exchange format may comprise one of, but not limited to, JSON, XML, RDF, CSV, HTML, Protobuf, cXML, DXF or a combination of the same.

Furthermore, the validation unit (210) may be configured to validate the set of cooking directions to check for format consistency, safety and quality. In an exemplary embodiment, the validation of the set of cooking directions may be performed in alignment with functionality of the device, one or more safety guidelines and one or more recipe ingredients validation rules.

Furthermore, the execution unit (211) may be configured to adjust the set of cooking directions based on the validation output from the validation unit (210). In an exemplary embodiment, adjustment to the set of cooking directions may include adjustment to one of ingredients, cooking temperature, time, speed and a combination of the same.

Furthermore, the execution unit (211) may be configured to split the set of cooking directions into one or more executable directions used for displaying on the UI coupled with the device. The user interface unit (205) may be configured to display the set of cooking directions, more specifically the one or more executable directions, on the UI coupled with the cooking device. In an embodiment, the user may interact with the UI, through voice command or text command, for executing the set of cooking directions (or the one or more executable directions) on the cooking device. In an exemplary embodiment, the user can also interact with UI coupled with the device for real-time guidance, asking questions about ingredient substitutions, cooking techniques or tips, or device related queries.

Furthermore, the execution unit (211) may be configured to utilize the AI model, to control one or more hardware components of the device for executing the set of cooking directions (or the one or more executable directions).

Moreover, the user interface unit (205) may be configured to receive one or more user instructions corresponding to the set of cooking directions. The one or more user instructions may comprise user feedback on the set of cooking directions, dietary preferences, available ingredients, personal taste, recipe modification instruction, device setting. Furthermore, the execution unit (211) may be configured to utilize the AI model, to control the one or more hardware components of the device, in real time, based on the one or more user instructions. Additionally, the execution unit (211) may be configured to utilize the AI model, to adjust the set of cooking directions, in real time, based on the one or more user instructions.

In an exemplary embodiment, the AI model may include one or more natural language processing (NLP) techniques, large language model (LLM), one or more classification model, the one or more speech recognition techniques, one or more image recognition techniques, one or more video recognition techniques, or a combination of the same. In an exemplary embodiment, the AI model may support one or more languages for generating the one or more text instructions, generating the set of cooking directions, and user interaction with the UI.

In an embodiment, the AI model may be configured to perform one or more tasks selected from one of generating a set of cooking instructions, real-time query assistance, real-time modification of cooking instructions.

Additionally, the user interface unit (205) may be configured to receive one or more user feedbacks, via the UI. In an exemplary embodiment, the one or more user feedback may include feedback related to the set of cooking directions, taste or device functionality. Moreover, the execution unit (211) may be configured to update the AI model based on the one or more user feedback. Updating the AI model may correspond to training the AI model with improved taste, latest recipes and device functionalities.

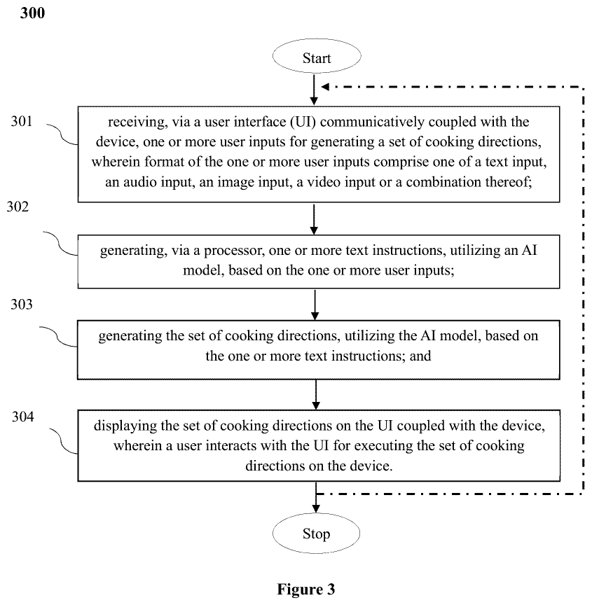

Now referring to FIG. 3, illustrates a flowchart describing a method (300) for assistive cooking, in accordance with at least one embodiment of the present disclosure. The flowchart is described in conjunction with FIG. 1 and FIG. 2. The method (300) starts at step (301) and proceeds to step (304).

In operation, the method (300) may involve a variety of steps for assistive cooking.

At step (301), the method (300) comprises a step of receiving, via the user interface (UI) communicatively coupled with the device, the one or more user inputs for generating the set of cooking directions. In an embodiment, format of the one or more user inputs may include one of the text input, the audio input, the image input, the video input or a combination of the same.

At step (302), the method (300) comprises a step of generating the one or more text instructions, utilizing an AI model, based on the one or more user inputs.

At step (303), the method (300) comprises a step of generating the set of cooking directions, utilizing the AI model, based on the one or more text instructions.

At step (304), the method (300) comprise a step of displaying the set of cooking directions on the UI coupled with the device. In an embodiment, the user may interact with the UI for executing the set of cooking directions on the device.

These sequence of steps may be repeated and continue till the user is stopped giving the user input or user instructions to the device.

Let us delve into a detailed example of the present disclosure.

### Working Example 1

Imagine a smart kitchen system designed to assist users in cooking a variety of dishes by accepting multiple forms of input, including text, audio, images, and videos. The user, for instance, might input an image of ingredients available in their kitchen, along with a voice command asking the system to generate a recipe based on those ingredients. The system, powered by an AI model, processes the image input to identify the ingredients and translates the voice command into a recipe query.

Based on this input, the system searches its database of recipes and generates a personalized set of cooking instructions that matches the user's available ingredients, dietary preferences, and cooking device specifications. Suppose the user prefers low-fat meals and has specified a preference for vegetarian dishes, the system adjusts the recipe accordingly, providing detailed steps and ingredient substitutions where necessary.

As the cooking progresses, the system displays step-by-step instructions on the user interface (UI) of a connected cooking device, such as a smart cooking device or smart oven. The user can also interact with the system in real-time, using voice commands to pause, skip, or modify instructions based on their needs. For example, if the user decides to modify the recipe, such as adding more seasoning or changing ingredients based on availability, they can instruct the system via voice or text input. The system then dynamically analyzes the new input and generates an updated version of the recipe, adjusting ingredient proportions, cooking time, and temperature as needed. For instance, if the user is missing a key ingredient or wishes to substitute a healthier alternative, the system intelligently reconfigures the recipe to accommodate the changes, ensuring that the cooking process remains seamless.

Throughout the cooking process, the system ensures that the user remains informed by sending real-time notifications, such as alerts when the dish is ready or when adjustments to cooking parameters are necessary. This adaptive, user-friendly approach makes the cooking experience more efficient, personalized, and convenient, especially for users with specific dietary needs or limited cooking experience.

### Working Example 2

Let's envision an assistive cooking system called “Intelligent Device” designed to automatically generate and adjust cooking instructions based on user inputs without the need for manual recipe adjustments. For instance, the user may interact with the Intelligent Device by providing a combination of audio, text, and image inputs such as listing ingredients, giving verbal preferences, and uploading an image of the dish they want to cook. The Intelligent Device processes these inputs using the AI model, generating a customized set of cooking directions that consider the user's dietary preferences, cultural preferences, and ingredient availability.

The user can further modify the recipe through voice commands or text inputs in real time, such as asking the system to reduce the spice level or substitute an unavailable ingredient. The Intelligent Device dynamically updates the cooking instructions, providing a seamless, personalized cooking experience. The system can display the steps on the user interface, where the user can follow the real-time instructions, while the AI simultaneously adjusts the cooking process to suit the user's evolving needs, making the Intelligent Device a highly adaptive and efficient cooking assistant.

A person skilled in the art will understand that the scope of the disclosure is not limited to scenarios based on the aforementioned factors and using the aforementioned techniques and that the examples provided do not limit the scope of the disclosure.

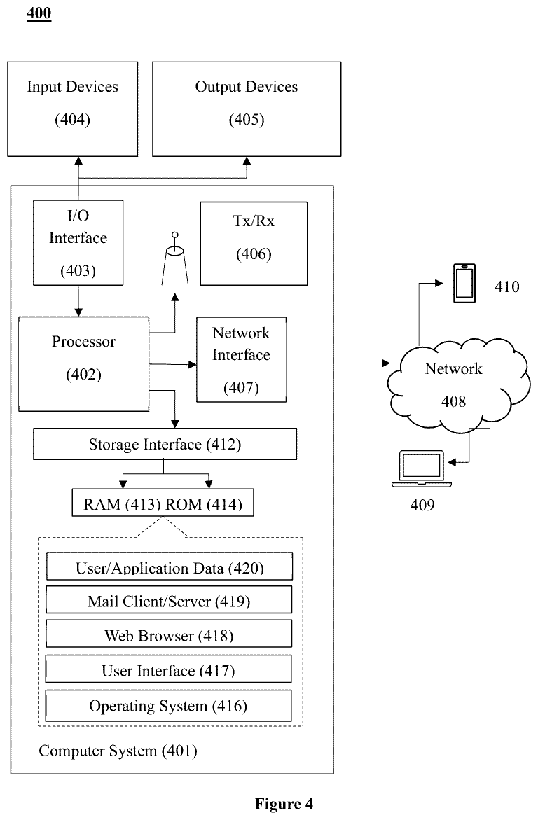

Now referring to FIG. 4, illustrates a block diagram (400) of an exemplary computer system (401) for implementing embodiments consistent with the present disclosure. Variations of computer system (401) may be used for assistive cooking. The computer system (401) may comprise a central processing unit (“CPU” or “processor”) (402). The processor (402) may comprise at least one data processor for executing program components for executing user-or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed of in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems' Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMS, Digital Video Disc (DVDs), flash drives, disks, and any other known physical storage media.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer for assistive cooking. The at least one code section in the application server (101) causes the machine and/or computer including one or more processors to perform the steps, which includes receiving (301) the one or more user inputs for generating the set of cooking directions. In an embodiment, the format of the one or more user inputs may include one of the text input, the audio input, the image input, the video input or a combination of the same. Further, the processor may perform a step of generating (302) the one or more text instructions, utilizing an AI model, based on the one or more user inputs. Furthermore, the processor may perform a step of generating (303) the set of cooking directions, utilizing the AI model, based on the one or more text instructions. Moreover, the processor may perform a step of displaying the set of cooking directions on the user interface (UI) coupled with the device. In an embodiment, the user may interact with the UI for executing the set of cooking directions on the device.

Various embodiments of the disclosure encompass numerous advantages including the system for assistive cooking. The disclosed system and method have several technical advantages, but not limited to the following:
Multi-Modal Input Processing: The system can receive and process various input formats such as text, audio, image, and video, offering users a flexible and convenient way to interact with the system, enhancing user accessibility and experience.
Real-Time Assistance: The system allows for real-time adjustments based on user feedback or changes in user inputs, ensuring that the cooking instructions remain dynamic and can be adapted as needed during the cooking process.
Personalized Cooking Directions: By utilizing the AI model, the system generates specific cooking instructions, offering a more customized approach to cooking based on the one or more user inputs.
Automated Safety and Quality Validation: The system validates the cooking instructions for consistency, safety, and quality, ensuring that the directions align with device functionality and safety guidelines, improving the reliability and trustworthiness of the system.
Automation and Efficiency: The system automates the process of generating, validating, and adjusting cooking directions, reducing manual effort and speeding up the cooking process.
User Feedback Loop: The system updates the AI model based on the received one or more user feedbacks related to taste, device functionality, and cooking instructions, allowing continuous learning and improving future cooking experiences.
Integration with Smart Devices: The system can directly control smart kitchen devices (e.g., cooking devices, microwave ovens) through AI-generated instructions, enabling seamless interaction between the system and hardware components without manual guesswork or adjustments for temperature, time, or speed.

In summary, these technical advantages solve the technical challenges associated with conventional cooking processes, including limited input flexibility, inaccuracies in interpreting various formats of user inputs, lack of dynamic modification options, and inadequate personalization. By utilizing an AI-driven approach to process one or more user inputs in the form of text, audio, image, and video, the system generates a specific set of cooking directions that align with the user's preferences. This dynamic adaptability allows for modifications based on dietary needs, cultural preferences, ingredient availability, and real-time user feedback, ensuring a personalized cooking experience. The system significantly enhances user satisfaction by offering greater flexibility, improving the accuracy of instructions, and reducing the time required for meal preparation.

The claimed invention of the system and the method for assistive cooking involves tangible components, processes, and functionalities that interact to achieve specific technical outcomes. The system integrates various elements such as processors, memory, databases, one or more vector databases, content extraction, comparison, and validation techniques. These elements collaboratively enable effective assistive cooking by processing and responding to one or more user inputs in various formats.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for assistive cooking, brings about an improvement and technical advancement in the field of cooking by receiving one or more user inputs.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

1. A system for assistive cooking, the system comprises:
a device communicatively coupled with a user interface (UI), wherein the device comprises:
a processor, and
a memory communicatively coupled with the processor, wherein the memory is configured to store one or more executable instructions including an artificial intelligence (AI) model, which cause the processor to:
receive one or more user inputs, via the UI, for generating a set of cooking directions, wherein format of the one or more user inputs comprise one of a text input, an audio input, an image input, a video input or a combination thereof;
generate one or more text instructions, utilizing the AI model, based on the one or more user inputs;
generate the set of cooking directions, utilizing the AI model, based on the one or more text instructions; and
display the set of cooking directions on the UI coupled with the device, wherein a user interacts with the UI for executing the set of cooking directions on the device.

2. The system as claimed in claim 1, wherein the processor is configured to:
generate a query vector based on the one or more text instructions; and
extract one or more content from one or more vector databases based on the query vector.

3. The system as claimed in claim 1, wherein the text input comprises recipe name, recipe description, list of ingredients, web address, or user queries; wherein the audio input comprise voice instructions from the user; wherein the image input comprises one or more images of ingredients, food dishes, or cooking instructions; wherein the image input corresponds to selecting one or more images stored in the memory; wherein the video input comprises video instructions from the user; wherein the video input corresponds to selecting one or more videos stored in the memory.

4. The system as claimed in claim 1,
wherein the generating of the one or more text instructions corresponds to interpreting the text input and categorizing into a plaintext, one or more web addresses or a combination thereof;
wherein the generating of the one or more text instructions corresponds to transcribing the audio input using one or more speech recognition techniques;
wherein the generating of the one or more text instructions corresponds to analyzing the image input using one or more image recognition techniques to identify textual description of ingredients, food dishes, or cooking instructions from the image input;
wherein the generating of the one or more text instructions corresponds to analyzing the video input using one or more video recognition techniques to identify textual description of ingredients, food dishes, or cooking instructions from the video input; and
wherein the generating of the one or more text instructions comprises translating language of the one or more user inputs into an English language.

5. The system as claimed in claim 3, wherein the one or more web addresses correspond to one of a video streaming platform address, a webpage address, or a combination thereof;
wherein the generating of the one or more text instructions comprises one of navigating to the webpage address, extracting recipe metadata from a webpage associated with the webpage address, downloading of video corresponding to the video streaming platform web address, extracting video metadata from the downloaded video, generating audio transcription of the downloaded video, summarization of the recipe metadata and the video metadata into one or more text instructions; and
wherein downloading of the video is performed by utilizing one or more application programming interface (API) corresponding to a video streaming platform associated with the video streaming platform address.

6. The system as claimed in claim 2, wherein the one or more vector databases comprise one or more vector content;
wherein extracting the one or more content is performed by comparing the query vector with the one or more vector content of the one or more vector databases based on one or more similarity scores and one or more predefined thresholds;
wherein each vector database from the one or more vector databases comprise one or more parameters selected from recipes, cooking modes, various cooking settings, device specific recipe structure, ingredient list and detailed ingredient-based information, cuisine and diet-based information and custom domain knowledge.

7. The system as claimed in claim 6, wherein the one or more vector databases are configured to periodically update the one or more vector content with latest recipe and device functionalities.

8. The system as claimed in claim 1, wherein the processor is configured to combine the one or more text instructions to form one or more AI compatible queries, wherein the AI model is configured to generate the set of cooking directions based on the one or more AI compatible queries; wherein the one or more AI compatible queries comprise the one or more user inputs, similar recipes, ingredients data, cuisine and diet data, device specific instructions, and custom settings.

9. The system as claimed in claim 2, wherein the processor is configured to generate the set of cooking directions, utilizing the AI model, based on the one or more content extracted from one or more vector databases, wherein the processor is configured to combine the one or more content to form one or more AI instructions, wherein the AI model is configured to generate the set of cooking directions based on the one or more AI instructions; wherein the one or more AI instructions comprise one or more user inputs, similar recipes, ingredients data, cuisine and diet data, device specific instructions, and custom settings.

10. The system as claimed in claim 1, wherein the processor is configured to generate the set of cooking directions in a predefined data exchange format, wherein the set of cooking directions in the predefined data exchange format comprise attributes from one of cooking time, steps-by-step guidelines, ingredient measurements, nutritional information, device-specific instructions, and a combination thereof.

11. The system as claimed in claim 1, wherein the processor is configured to validate the set of cooking directions to check for format consistency, safety and quality; wherein the validation of the set of cooking directions are performed in alignment with functionality of the device, one or more safety guidelines and one or more recipe ingredients validation rules; wherein the processor is configured to adjust the set of cooking directions based on the validation; wherein adjustment to the set of cooking directions comprises adjustment to one of ingredients, cooking temperature, time, speed and a combination thereof.

12. The system as claimed in claim 1, wherein the processor is configured to split the set of cooking directions into one or more executable directions for displaying on the UI coupled with the device; wherein the user interacts with the UI, through voice command or text command, for executing the set of cooking directions on the device; wherein the processor is configured to utilize the AI model, to control one or more hardware components of the device for executing the set of cooking directions.

13. The system as claimed in claim 1, wherein the processor is configured to receive one or more user instructions corresponding to the set of cooking directions, wherein the processor is configured to utilize the AI model, to control the one or more hardware components of the device, in real time, based on the one or more user instructions; wherein the processor is configured to utilize the AI model, to adjust the set of cooking directions, in real time, based on the one or more user instructions.

14. The system as claimed in claim 1, wherein the AI model comprises one or more natural language processing (NLP) techniques, large language model (LLM), one or more classification model, the one or more speech recognition techniques, one or more image recognition techniques, one or more video recognition techniques, or a combination thereof; wherein the AI model supports one or more languages for generating the one or more text instructions, generating the set of cooking directions, and user interaction on the UI, wherein the AI model is configured to perform one or more tasks selected from one of generating a set of cooking instructions, real-time query assistance, real-time modification of cooking instructions.

15. The system as claimed in claim 1, wherein the processor is configured to receive one or more user feedbacks; wherein the one or more user feedback comprise feedback related to the set of cooking directions, taste or device functionality; wherein the processor is configured to update the AI model based on the one or more user feedbacks; wherein updating the AI model corresponds to training the AI model with improved taste, latest recipes and device functionalities.

16. The system as claimed in claim 1, wherein the device corresponds to one of a cooking device, a blending device, a microwave oven, and other smart kitchen devices.

17. A method for assistive cooking in a device, the method comprises:
receiving, via a user interface (UI) communicatively coupled with the device, one or more user inputs for generating a set of cooking directions, wherein format of the one or more user inputs comprise one of a text input, an audio input, an image input, a video input or a combination thereof;
generating, via a processor, one or more text instructions, utilizing an AI model, based on the one or more user inputs;
generating the set of cooking directions, utilizing the AI model, based on the one or more text instructions; and
displaying the set of cooking directions on the UI coupled with the device, wherein a user interacts with the UI for executing the set of cooking directions on the device.

18. A non-transitory computer-readable storage medium having stored thereon, a set of computer-executable instructions causing a computer comprising one or more processors to perform steps comprising:
receiving one or more user inputs for generating a set of cooking directions, wherein format of the one or more user inputs comprise one of a text input, an audio input, an image input, a video input or a combination thereof;
generating one or more text instructions, utilizing an AI model, based on the one or more user inputs;
generating the set of cooking directions, utilizing the AI model, based on the one or more text instructions; and
displaying the set of cooking directions on a user interface (UI) coupled with a device. wherein a user interacts with the UI for executing the set of cooking directions on the device.
